(19) United States
(12) Patent Application Publication
(10) Pub. No.: US 2015/0161683 A1
(43) Pub. Date: Jun. 11, 2015

(54) INCENTIVIZING PLAY OF AUDIO/VISUAL MATERIAL

(71) Applicant: Sherman Pegross, West Bloomfield, MI (US)

(72) Inventor: Sherman Pegross, West Bloomfield, MI (US)

(21) Appl. No.: 14/563,208

(22) Filed: Dec. 8, 2014

Related U.S. Application Data
(60) Provisional application No. 61/913,640, filed on Dec. 9, 2013.

(51) Int. Cl. G06Q 30/02; G06Q 30/06; H04L 29/08

(52) U.S. Cl. CPC G06Q 30/0277; H04L 67/02; H04L 67/22; G06Q 30/0601

(57) ABSTRACT

A system and method for incentivizing play of audio and visual material. An application server receives and stores uploaded audio material, visual material, or a combination thereof. A desktop application that is downloaded to a user computing device, handheld device, or a combination thereof, and the desktop application is programmed to allow the user to listen to and view the material uploaded to the application server. The application server is programmed to govern how the material is viewed and how users are paid for viewing and listening to uploaded material.

### CROSS REFERENCE TO RELATED APPLICATIONS

This application claims the benefit of the priority date of U.S. Provisional Patent Application No. 61/913,640, entitled “Incentivizing Play of Audio/Visual Material”, filed Dec. 9, 2013.

### BACKGROUND OF THE INVENTION

1. Field of the Invention

This invention relates generally to a system and method of incentivizing-g play of audio/visual material and the software used to perform the same and, more particularly, a platform that is provided to audio and/or visual content artists, where users such as disc jockeys (DJs) are able to interface with the platform to access the audio and/or visual content.

2. Discussion of the Related Art

In a typical audio and/or visual system, users would simply play popular material while ignoring other lesser known materials. Thus, there is a need in the art for a system and method that provides artists of lesser known materials a way to achieve at least some level of exposure.

### BRIEF DESCRIPTION OF THE DRAWINGS

FIG. 1 is an illustration of an audio/visual content sharing and playback computing system;

FIG. 2 is an illustration of an exemplary database diagram; and

FIG. 3 is an illustration of an exemplary listener application module.

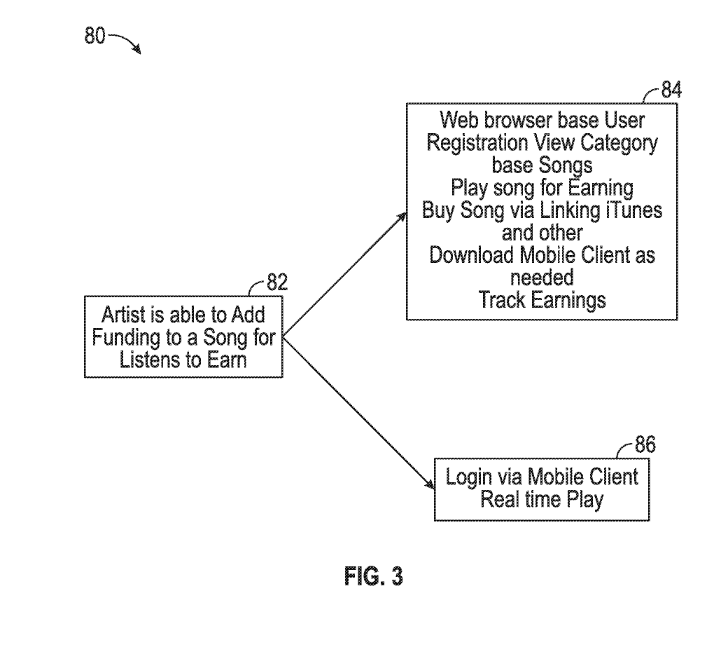

### DETAILED DESCRIPTION OF THE EMBODIMENTS

The following discussion of the embodiments of the invention directed to incentivizing play of audio/visual material and the software used to perform the same is merely exemplary in nature, and is in no way intended to limit the invention or its application or uses.

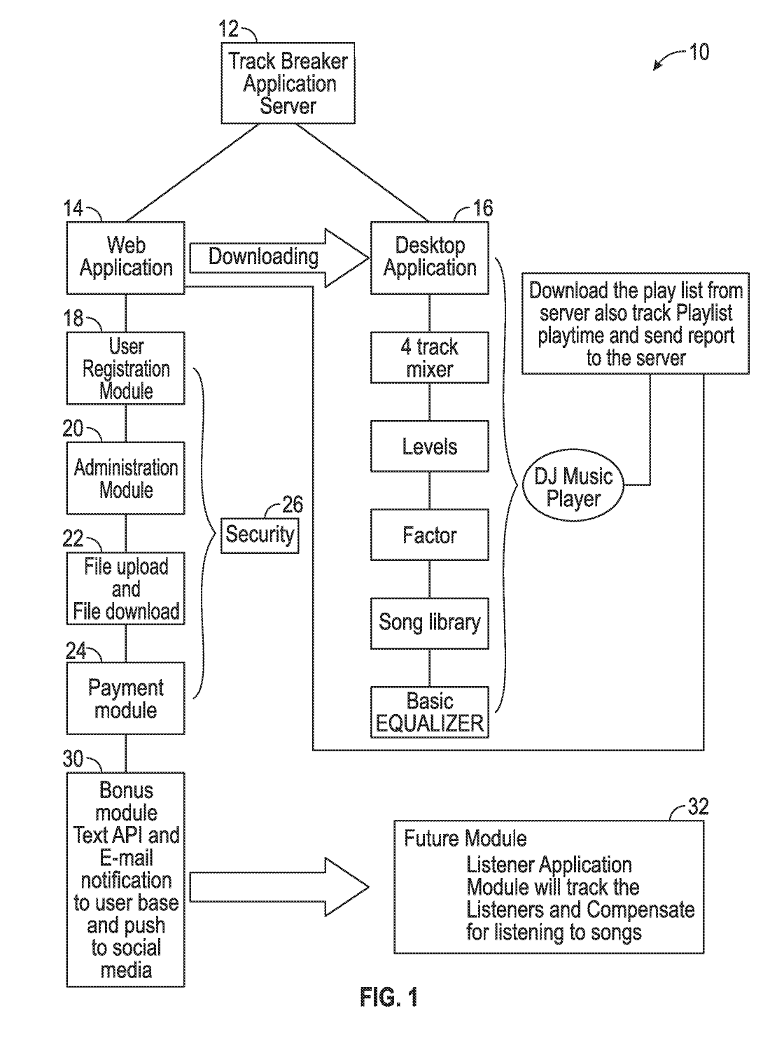

FIG. 1 is an illustration of an audio/visual content playback computing system 10 that includes a track breaker application server 12, a web application 14, and a desktop application 16. As will be described in more detail below, the system 10 is configured and programmed to encourage the users to play all of the audio/visual material that is available and not just popular audio/visual material. This provides artists that would otherwise be ignored with at least some level of exposure to listening/viewing audiences. Once a user of the system 10 has satisfied system requirements to play a sufficient number of different and/or diverse audio/visual materials, the user is permitted to seek out and play materials of their choice, such as popular material. Incentives are provided to the user to play the different and/or diverse audio/visual material. Additionally, various information is gathered from users and artists of the audio/visual material by the system 10, as is described in more detail below. By way of example, location information of users and artists may be gathered. Any time of information may be gathered, location information in merely exemplary. The system 10 is on a HTML5 responsive design so that it will be functioning on popular browsers like Google Chrome, Internet Explorer, Mozilla, and Safari, as well as mobile browsers.

The track breaker application server 12 allows artists to upload their audio/visual material and also allows users to download audio/visual material for playing, adding to a playlist, etc. The web application 14 connects all components of the system 10 together and also provides visibility for all transactions of the system 10. Three roles of use of the system 10 are managed by the web application: (1) an administrative role; (2) an artist role; and (3) a disc jockey (DJ) role. At a user registration module box 18, artists and DJs are able to sign up with the system 10. When these two types of users sign up at the box 18, they will be given a user agreement (a DJ agreement or an artist agreement, as appropriate) to accept depending on the type of role the user is using the system 10 for. This will allow the user (whether administrator, artist or DJ) to log into the system 10 and access their home page, where the home page is different for each type of role. If a user forgets their password a typical password recovery mechanism may be used, as is known to those skilled in the art. The recovery details will only be sent to the user's registered email account.

At an administrator module box 20, an administrator may set up or change rate structures of the system 10. The following rate structures may be part of the system 10 and may be changed by the administrator: (1) rate for a DJ spin; (2) rate for publishing a song for an artist; (3) a DJ annual subscription fee for DJ users (by way of non-limiting example, a subscription fee of $20/month or $240/year); (4) an artist registration fee; (5) a commission fee paid to a system administrator/owner (by way of non-limiting example, a fee that is a percentage of the DJ spin); and (6) a bonus scheme.

Additionally, at the administrator module box 20, the administrator may create a list of genres for songs, where the genres are used by user artists when the songs are uploaded and also used when displaying the songs such that songs are displayed according to genre. Furthermore, the administrator may create a market based on geographies at the box 20, where a “market” may be considered as a geographical area.

At a file upload and file download box 22, artist users may browse their own digital media, e.g., songs from their won MP3 player, and/or from their local computer drives, and then upload desired songs to the system 10. The genre of the song as well as the market may be selected by the artist user before the song is uploaded at the box 22. The uploaded media will not be visible to other users/the public until it is reviewed by staff, e.g., the administrator, and approved. The media uploaded at the box 22 by a user artist may not exceed a system 10 maximum publishing/uploading threshold that is set by the system 10 per user artist. Furthermore, each media, e.g., each song, has a predetermined publish period that is set such that the period will expire at some date from the publish date, e.g., 30 days from publishing. Thereafter, the user artist may be entitled to republish at the box 22. Any unused funds from a previous publish may be rolled into a next publish. A DJ user will not be entitled to earn a fee by spinning songs that are not/are no longer published. Unpublished song(s) will be highlighted on the DJ user desktop application to notify the DJ that the song(s) are unpublished or the credits are over for that song.

The box 22 also allows artists, DJs and/or the administrator to browse uploaded and approved songs, where the songs are displayed for browsing according to genre and market categorization. Further, search criteria can be defined to narrow the song list. Search parameters may include the following: (1) artist name (including first and last); (2) last played location; (3) play by DJ (including first and last name); (4) currently published (yes/no); and (5) credit remaining (yes/no).

At a payment module box 24, artists may make payments to the system 10 when publishing songs using a secured payment gateway, as represented at a security box 26. The payments gateway at the box 26 is a secured HTTP service with 128 bit or more encryption. The data about the song plays will be stored in an encrypted mode with an encryption key embedded as described in more detail below. Once the transaction is complete, an account balance is updated and displayed under an artist's account. Any credit card or debit card may be used to make payments to the system 10.

The payment module box 24 also enables DJs to claim payments by sending monthly claims for their spins, and the system 10 will make the payments to, for example, a PayPal account that has been set up by the DJ. Once payments are made, a balance of the DJ account is updated and the DJ will be able to see the updated balance as well as the transaction details under their profile/account.

A DJ user or artist user may cancel their account and withdraw their contract with the system 10. A respective account will be reviewed by staff of the system 10 and a decision will be made to close the financial transactions.

A DJ may browse through a song collection and make songs under limitations set by the administrator. Marked songs will be downloaded to a DJ's desktop application at the desktop application box 16 at a next synchronization. However, a DJ may not select a song to play. The DJ must accept available songs based on next available from a genre list. This method gives all artists a fair chance to be heard. After a DJ accumulates at least sixteen minutes of paid plays, that DJ is given freedom to search for and select a song of choice to play.

To view or change a user profile, a DJ, artist and/or administrator may be able to view/change the appropriate profile settings under their web account, depending on the role. Table 1 is a list of profile settings that may be viewed/changed:

TABLE 1

| | | Artists: | | | |
|---|---|---|---|---|---|
| Personal | Payment | Performance | | | |
| Details | Details | Information | DJs | Preferences | Administrator |
| First name | PayPal for | Artists' | How long have | Artist & DJ: | Maximum number of songs |
| | DJs and Credit | Group Name | you been a DJ? | | can be downloaded by |
| | Card for | | | | the members who have not |
| | Artists | | | | completed X minutes paid |
| | | | | | spins yet |
| Last name | | Label name | What is your | Favorite | The variable X of previous |
| | | | DJ moniker? | Genres | statement |
| Address | | Origin | Please list your primary | | Maximum number of songs |
| | | | genres: (list of genres, | | can be published by an |
| | | | including “Other”; if | | artist in a month |
| | | | “Other” is selected, | | |
| | | | please provide info) | | |
| City, State, | | Genre | How do you play your music? | | Minimum venue size and |
| Zip | | | (choose one: vinyl, CD, MP3) | | audience for DJ |
| Phone | | What is the title of the | If MP3, do you play via CD | | |
| number | | song(s) being submitted? | turntable, vinyl turntable, | | |
| | | | iPod or other? (if other, how?) | | |
| Email | | Has the song(s) you are now | How many days a week do you play | | |
| address | | submitting been previously | to a live audience? | | |
| | | published? (If yes, when and | | | |
| | | by whom?) | | | |
| Website | | Are you the owner of the musical | How many days a week do you play | | |
| | | work(s) being submitted? | to a radio audience? | | |
| Photo | | Do you need/want help | How often do you play to a | | |
| | | publishing your song(s)? | television (live or | | |
| | | | prerecorded) audience? | | |
| | | Has the song(s) being submitted | Are you a regular on any | | |
| | | been previously released? (If | television or radio | | |
| | | yes, when, where and | stations? | | |
| | | how released?) | | | |
| | | Do you need/want help | Do you work for a | | |
| | | releasing your songs? | television or radio | | |
| | | | station? (If yes, which | | |
| | | | station(s)?) | | |
| | | | Have you ever been on tour | | |
| | | | with any type of group or band? | | |
| | | | (If yes, when and for whom?) | | |
| | | | Do you have any tours or | | |
| | | | traveling scheduled in the | | |
| | | | near future? (If yes, | | |
| | | | when and where?) | | |
| | | | Have you ever play to any of | | |
| | | | the following audience: | | |
| | | | (please select all that | | |
| | | | apply: concert, hair | | |
| | | | show, fashion show, | | |
| | | | wedding reception, block | | |
| | | | party, banquet, fund | | |
| | | | raiser, family reunion, | | |
| | | | other; if other please | | |
| | | | explain) | | |
| | | | Would you consider | | |
| | | | yourself a Professional | | |
| | | | DJ or an Amateur | | |
| | | | DJ? | | |
| | | | If your application is | | |
| | | | approved, will you | | |
| | | | play Track Breaker songs | | |
| | | | in your regular sets? | | |

Account details may be viewed in a transaction detail report. The transaction detail report will display all of the financial details for an account for the last 30 days by default. A user can also expand their search for a given time period. The report may contain the following information: (1) transaction date and time; (2) transaction type (paid/received); (3) details (song details or payment details); (4) amount (plus or minus depending on the role and transaction type); (5) payer/payor; (6) receiver/payee; and (7) payment settlement date and time.

DJ play details may also be viewed in a report that shows all DJ sessions played during, for example, the last 30 days by default. A user may expand the search for a given time period. Future planned DJ may also be displayed if a FUTURE check box is selected. Furthermore, a DJ will be able to enter details such as when and where for future planned DJs. Other information that the report may contain includes: (1) DJ date and time; (2) time zone; (3) venue; (4) venue size; and/or (5) audience.

A song play/download details report may also be generated by the system 10. A DJ or administrator may view details of the songs played within, for example, the last 30 days. A user is able to expand the search for any time period desired. The song play/download details report also displays the credits used for each song if the DJ played the songs in accordance to rules defined by the system 10. If a particular song play(s) did not earn for a DJ, a details column in the song play/download details report will explain the reason(s) why. The reason may be one of the following reasons: (1) no existing credits from the artist(s); (2) DJ is not from the target market; (3) DJ has not met the minimum requirements for DJ play in accordance with the system 10; (4) play duration was not sufficient; (5) other simultaneous paid spin was present; (6) played out of the temporal margins; (7) the song was not downloaded from the system 10.

Additional information the song play/download details report may include: (1) DJ name; (2) downloaded date/time; (3) played date time; (4) played seconds; (5) played volumes; (6) RPM; (7) venue; (8) song ID; (9) song name; (10) artist name; (11) paid amount; (12) details.

A notification module 30 is integrated with the web application 14 and is used to provide a notification process for a system 10 application for e-mail and SMS along with social media push. A recommended API is http://message-media.com/sms-gateway.html. When a new song list is available an email/SMS is sent to all DJs in the system 10. A user DJ's profile page may include a TURN ON or OFF option for the notifications. Further, bank amounts may be sent via email/SMS using the notification module 30 when a bank limit reaches a default level set by the administrator. A second notification may be sent via email/SMS using the notification module 30 when bank amounts fall to $0.

Using social media such as facebook, Twitter and/or Google+, an API posting may occur when an artist uploads a song or reloads money. Other social media may be used to bring in potential link building using API or build an application best solution.

The system 10 may allow artists to offer bonus points to a DJ(s) if the DJ submits video proof of the song play to the artist. For example, a DJ may upload the song(s) to YouTube or other social media and share the link of the played/shared song(s) details so that the artist is able to see the proof of the song(s) played. To offer bonus points to DJs, an artist selects a value from a bonus points list that has been predetermined by the administrator. The system 10 will take the bonus point credits from the artists account and add the bonus point credits to the DJ's account.

The desktop application 16 of the system 10 is used primarily to provide the DJ users with play functions. The desktop application 16 keeps track of song play details including: (1) song title; (2) song ID; (3) start time; (4) stop time; and (5) total number of seconds played/stopped. Volume changes are also tracked by the desktop application 16. Using an encryption key embedded in software of the desktop application 16, the tracked data is encrypted and kept in a folder of the desktop application 16 until it is synced with the server 12. Decryption occurs on a system server using a system decryption key.

Software for the desktop application 16 must be downloaded and installed on a DJ's computer for the DJ to claim credit for songs played by the DJ, which must be done using the desktop application 16. The software may be used with Microsoft Windows and Apple Mac Operating Systems. The DJ must also be a registered DJ user of the system 10 to use and install the desktop application 16. The DJ will require a username and password ready after installing the desktop application 16. Any person, whether registered or not, and whether a DJ user or not, may download the desktop application 16. To be eligible for credits/payments, the user must login with a profile and an account subscription that is current.

To run the desktop application 16, installation must be complete. The software will run with the complete set of features without registration. Once installed, if the desktop application 16 detects an internet connection on the computer it is installed, it will prompt the user to sync software with the application server 12. In the synchronization process, the desktop application 16 will download the playlists and the songs marked by the DJ for downloading from the application server 12. A user may also set up an automatic sync option to allow the software to perform the synchronization without intervention. If the automatic sync option is enabled, the desktop application will sync every time it starts. Synchronization is a background process running on the user's computer and the status will be updated on a status bar of the application. The following data is exchanged between the server 12 and a user's computer with the desktop application 16 during synchronization: (1) songs marked for downloading (server 12 to desktop application 16); (2) song play details (server 12 to desktop application 16); (3) DJ session details (desktop application 16 to server 12, uncles changes are noticed from the server).

Play session details may be managed by the DJ using the desktop application 16. The following need to be set by the DJ to create a DJ session: (1) DJ date/time; (2) venue; (3) venue size; (4) audience. Additionally, using the desktop application 16, a DJ is able to create playlists by selecting songs from a local drive that includes a folder for the system 10. Playlists may be modified by adding or removing songs to/from the playlist. The DJ is further able to remove a playlist if the playlist is not required. Songs on a playlist will be played sequentially from top to bottom according to the playlist when a play function is executed. The DJ is able to load a playlist for each track, up to four tracks.

Loading and playing an in individual song on to a track (the desktop application 16 will support a maximum of for tracks at a time), will cancel a currently playing song and will start playing the loaded and played song. When the songs are loaded for playing, the desktop application 16 will show any remaining credits for the songs if an internet connection is available. When a song is played using the desktop application 16, the artist of the song will be notified by means of email/SMS if an internet connection is available for the desktop application 16. When a DJ downloads a song from the server 12, the song is downloaded with its available credits displayed. Even if the internet is not available, the software will track the played time and update when reconnected.

The desktop application 16 also allows DJs to change the volume levels of individual tracks independently. Maximum volume levels are subject to the capabilities of the sound card installed on the DJ's computer/system that includes the desktop application 16. The desktop application 16 includes an individual channel volume as well as a master volume.

A DJ may also use a slider that is available on the desktop application 16 to fade from one song to another song if two songs are being played simultaneously. The fader/slider will work between first and second (fader 1), second and third (fader 2), and third and fourth (fader 3) tracks. Furthermore, a basic 3 channel equalizer is part of the desktop application 16 to adjust the bass, treble and mid-range. Equalizer settings will affect all four tracks of the desktop application 16 at the same time. Each individual channel will have its own equalizer as well as a master equalizer.

As previously stated, a DJ will be able to load four songs onto four tracks of the desktop application 16. Preference settings are displayed on a screen of the desktop application 16 to allow a user to change the preference settings. This can be accessed from the menu, and the preference setting will include: (1) the system 10 local folder; (2) user name; (3) password. Note that the username and password must be matched with the server 12 for the user to sync the desktop application 16 with the server 12.

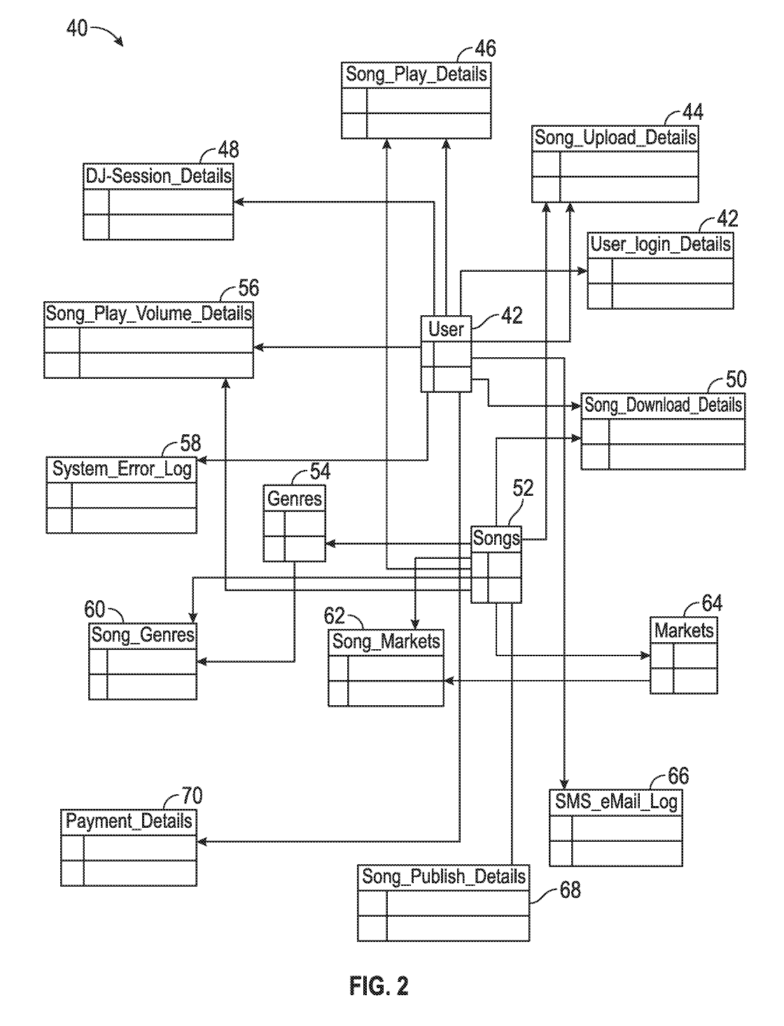

FIG. 2 is an exemplary database diagram 40 of functions a user of the system 10 may use once the desktop application 16 is installed. For example, a user at a box 42 may login and view user login details at a box 42. The user 42 may also view song upload details at a box 44, song play details at a box 46, and DJ session details at a box 48. Song download details may be accessed at a box 50, and songs may be viewed/accessed at a box 52. As stated above, songs are uploaded to the server 12 before they can be accessed using the desktop application 16. Genres may be viewed/accessed at a box 54, song play volume details may be viewed/accessed at a box 56, and a system error log may be viewed/accessed at a box 58. Songs may be viewed/accessed according to genre at box 60, or according to song markets at box 62. Markets may be viewed/accessed at box 64. A SMS/email log may be viewed/accessed at box 66, song publish details may be viewed/accessed at box 68, and payment details may be viewed/accessed at box 70.

A listener application module 32 may also be part of the system 10 to expand money allocation to song from user artist side, or user registration from a public side using the Internet or a mobile device. The listener application 32 may include real time play time tracker using a web browser or a mobile client. The add-on feature to the system 10 with additional user-type management with mobile browser compatibility may be included, as shown at the boxes 84 and 86. For example, iPhone, iPad, Android and Windows mobile clients may access the system 10 via, for example, Native SDK and HTML5/Phonegap/JQuery mobile.

Table 2 is a list of options that users of the system may utilize:

TABLE 2

| | User Option - | |
|---|---|---|
| | This is General | |
| Artist Option | Public | Reports |
| song writer/artist uploads a song to the | A. Registration (first name, last | Show songs, lesson time and |
| system and LOAD ex amount of money to | name, email, pick payment option) | amount earned |
| be paid to DJ's there we need incorporate | | |
| process | | |
| LOAD ex amount of Money for the | | |
| “Listener” application/process | | |
| View Listener Report (for a song-how | a. PayPal Info for - Payment | Payment reports (payment process |
| many people played the song above 15 | processing | by system −25% fee) |
| seconds and play time) | | |
| User ID/Play time/Payout (auto sum at | b. Payment by Check (If pay by | Other features on Registration: (1) put |
| the end) | check option is picked must fill | limit of accumulation of |
| | out: | $10 minimum before payout; (2) |
| | Address | agree to terms and Policy; (3) link to |
| | City | creating PayPal account - as NEW |
| | State | TAB OR POP UP |
| | Zip code | |
| Total users | Registration fee | Web login need to be working with all |
| | | Main browsers and player SDK for |
| | | IPAD/IPHONE, Android |
| Time of Play | Subscriber agreement | |
| Total payout (auto link to upload money to | User Name-email address (need to | |
| the song; buy button clicks per song; song | be valid email) | |
| name/number of buy button clicks) | | |
| | PW | |
| | Email and PW must validate 2x | |
| | Add security pin for extra | |
| | validation | |
| | Define interest by type of music | |
| | Define location - per system | |
| | regions | |
| | From dash board REVIEW | |
| | available play list (songs with | |
| | payment/bank $$ available real | |
| | time available funding | |
| | Lesson to via play button (must | |
| | lesson to 15-30 second for play | |
| | counter to start; count from 15 | |
| | Sec on 0.04 per second; end of | |
| | song show amount money | |
| | earned - per song; BUY Link | |
| | to navigate and buy the song | |
| | (track link as count for artist | |
| | report) | |

The system 10 lists payout songs by category, artist name, and update bank real time stream song when CLICK PLAY track 15 second play time, then start count of play time. The system 10 also auto-calculates the payout and credit user profile and deducts from a bank account in real time. A track Buy Link Clicks count by song is part of an artist report.

The administrator is capable of managing a payout rate (e.g., may change the $0.04 payout rate), may manage the startup tracking time (e.g., 0.15 seconds of minimum play time before crediting a user for time of play payment tracking). Administrator reports may be generated by the system 10, and may be generated by song track (i.e., users that played a particular song), BUY song track buy button clicks, user reports by region, and/or TURN OFF SMS API notification.

System notifications may notify a listener application registered user of the availability of a song via email/text and may notify artists via email/text when the funds fall below, for example, $10.00 for the song so that the artist may upload more money. Registered listeners may earn money for listening, but once a song has been paid all out, the listener may not hear the song again unless: (1) the artist of the song replenishes funds for the song and the listener is lucky enough to catch it again; or (2) the listener clicks the buy button to purchase the desired song from the system 10 via a for sale download option that is available to users. Although the listener may not be able to hear a song again, there is a listened-song history to refer to.

When submitting payment to a user, the system automatically deducts a predetermined amount, for example, 25% from the total. The 25% deduction is merely exemplary as any deduction amount may be used. When paying by check, the system 10 allows the administrator to put check information such as check number, amount, % depiction, and allow profiles to be updated for an earning report.

A listening security feature may also be part of the listening module 32 to safeguard against any listener who should fall asleep while listening when that listener should be listening. This is particularly important if the listener is to be paid for listening. For example, the listening security feature may be such that when the listener selects a desired genre of music, the paid listening for the first song begins after 1:30 minutes of play time of that song for new listeners. Thus, the first 1:30 minutes of the song play time is tolling and counting down. When 15 seconds are remaining on a timer, an indicator (e.g., an audio and/or visual indicator) will alert that paid listening will stop in 15 seconds, although the music shall continue. At the time of the 15 second indicator, the listener can do one of several things to sustain paid listening that include, but are not limited to: a manual action such as clicking on a “continuation” button; or an automatic option such as tapping the screen of the device on which the desktop application 16 is installed, or rotating the screen (for handheld devices), or changing volume. Furthermore, a camera lens of the listener's device may be used as a motion detector to indicate that the listener is listening to the song play. For the manual action, the listener may press the “continuation” button up to a predetermined maximum threshold. By way of example, a new listener may press the “continuation” button for a maximum of 1:30 minutes. For the automatic option, paid listening may continue automatically as long as the device detects constant movement before paid time is to stop. For example, constant movement may include tapping the screen, rotating the screen and/or changing the volume.

Table 3 is an illustration of development technology for listener JAVA/AJAX/MYSQL web application:

TABLE 3

| | | |
|---|---|---|
| Propose Listener | Support Devices: | http://phonegap.com/ |
| Module-mobile/hand- | 1. IOS (iPhone and iPad) | HTML 5 Responsive |
| held devices | 2. Android | |
| | 3. Windows 8 | |
| | 4. Blackberry | |
| Propose Listener | Listener Web Appli- | JAVA/AJAX |
| Module Web | cation Development | |

A MYSQL server is used as a back end of the system 10, where the system 10 only has connectivity to the MYSQL server. The desktop application 16 will not be directly accessing the database of songs/uploads, but will do so only through the server 12.

As will be well understood by those skilled in the art, the several and various steps and processes discussed herein to describe the invention may be referring to operations performed by a computer, a processor or other electronic calculating device that manipulate and/or transform data using electrical phenomenon. Those computers and electronic devices may employ various volatile and/or non-volatile memories including non-transitory computer-readable medium with an executable program stored thereon including various code or executable instructions able to be performed by the computer or processor, where the memory and/or computer-readable medium may include all forms and types of memory and other computer-readable media.

The foregoing discussion discloses and describes merely exemplary embodiments of the present invention. One skilled in the art will readily recognize from such discussion and from the accompanying drawings and claims that various changes, modifications and variations can be made therein without departing from the spirit and scope of the invention as defined in the following claims.

What is claimed is:

1. A system for incentivizing play of audio and visual material, said system comprising:
an application server that receives and stores uploaded audio material, visual material, or a combination thereof; and
a desktop application that is downloaded to a user computing device, handheld device, or a combination thereof, said desktop application programmed to allow the user to listen to, view and share the material uploaded to the application server, said application server programmed to govern how the material is listened to, viewed and shared, and how users are paid for listening, viewing and sharing the material.

2. The system according to claim 1 further comprising an administrator of the system, said administrator monitoring the audio and visual material uploaded and payments received and paid out among the various users.

3. The system according to claim 1 wherein a user may be an artist that uploads material, a disc jockey that plays material, a listener, or a viewer of the material, or a combination thereof.

4. The system according to claim 1 further comprising programming the application server and the desktop application to encourage users to play all of the audio material and the visual material that is uploaded to provide artists that would otherwise be ignored with a level of exposure to audiences.

5. The system according to claim 4 further comprising programming the application server and the desktop application to allow users to seek out the material of their choice after they have played, listened to, viewed or shared a predetermined amount of different materials.

6. The system according to claim 1 further comprising programming the application server and the desktop application to gather information about users of the system.

7. The system according to claim 1 further comprising a web application that connects the application server and the desktop application that has been downloaded to a user computing device, handheld device, or combination thereof.

8. The system according to claim 7 wherein the web application manages users according to user role, where a user may be using the system in an administrative role, an artist role, a disc jockey role, or a listener role.

9. A system for incentivizing play of audio and visual material, said system comprising:
an application server that receives and stores uploaded audio material, visual material, or a combination thereof;
a desktop application that is downloaded to a user computing device, handheld device, or a combination thereof, said desktop application programmed to allow the user to play the material uploaded to the application server, said application server programmed to govern how the material is played and how payments are allotted to users that play the material; and
a web application that connects the application server and the desktop application that has been downloaded to a user computing device, handheld device, or combination thereof.

10. The system according to claim 9 further comprising an administrator of the system, said administrator monitoring the audio and visual material uploaded and payments received and paid out among the various users.

11. The system according to claim 9 wherein a user may be an artist that uploads material, a disc jockey that plays material, or a combination thereof.

12. The system according to claim 9 further comprising programming the application server and the desktop application to encourage users to play all of the audio and visual material that is uploaded to provide artists that would otherwise be ignored with a level of exposure to audiences.

13. The system according to claim 12 further comprising programming the application server and the desktop application to allow users to seek out the material of their choice after they have played a predetermined amount of different materials.

14. The system according to claim 9 further comprising programming the application server and the desktop application to gather information about users of the system.

15. The method according to claim 9 wherein the web application manages users according to user role, where a user may be using the system in an administrative role, an artist role, or a disc jockey role.

16. A method for incentivizing play of audio and visual material, said method comprising:
providing an application server that receives and stores uploaded audio material, visual material, or a combination thereof;
providing a desktop application that is downloaded to a user computing device, handheld device, or a combination thereof, said desktop application programmed to allow the user to play the material uploaded to the application server, said application server programmed to govern how the material is played and how payments are allotted to users that play the material; and
providing a web application that connects the application server and the desktop application that has been downloaded to a user computing device, handheld device, or combination thereof.

17. The method according to claim 16 wherein an administrator of the system monitors the audio material and the visual material and determines whether the material is acceptable, and where the administrator determines and monitors payments received and paid out among users of the system.

18. The method according to claim 16 wherein a user may be an artist that uploads material, a disc jockey that plays material, or a combination thereof.

19. The method according to claim 16 further comprising programming the application server and the desktop application to encourage users to play all of the audio material and the visual material that is uploaded to provide artists that would otherwise be ignored with a level of exposure to audiences.

20. The method according to claim 19 further comprising programming the application server and the desktop application to allow users to seek out the material of their choice after they have played a predetermined amount of different materials.
